(19) United States
(12) Patent Application Publication
(10) Pub. No.: US 2016/0379187 A1
(43) Pub. Date: Dec. 29, 2016

(54) ELECTRONIC RECEIPT SYSTEM

(71) Applicants: Mark Wijngaarden, Nieuw-Vennep (NL); Ranvish Vir, Amsterdam (NL)

(72) Inventors: Mark Wijngaarden, Nieuw-Vennep (NL); Ranvish Vir, Amsterdam (NL)

(21) Appl. No.: 15/187,867

(22) Filed: Jun. 21, 2016

Related U.S. Application Data
(60) Provisional application No. 62/185,759, filed on Jun. 29, 2015.

(51) Int. Cl. G06Q 20/04; G06Q 20/20

(52) U.S. Cl. CPC G06Q 20/0453; G06Q 20/204

(57) ABSTRACT

A bank identity for an electronic payment tool of a user is created by an e-receipt company computer system and it is associated with a user identity. The bank identity is sent to a bank computer system and it gets associated with a bank account maintained at a financial institution. The bank identity and a transaction details data are sent to the e-receipt company computer system and to a store system upon receiving a request for payment with use of the electronic payment tool at the store system. The store system sends a receipt data and the transaction details to the electronic receipt company computer system. The e-receipt company computer system combines the user identity, the receipt data and the transaction details data based on a transaction identity included in the transaction details data to generate an electronic receipt which is made accessible through a client device over a network.

### CROSS-REFERENCE TO RELATED APPLICATIONS

This application claims the benefit of U.S. Provisional Application No. 62/185,759, entitled “ELECTRONIC RECEIPT SYSTEM” filed Jun. 29, 2015, the contents of which are incorporated herein by reference.

### FIELD OF THE INVENTION

The present invention generally relates to financial transactions. More particularly, the present invention relates to generation, storage and distribution of electronic receipts against point-of sale and/or other electronic transactions.

### BACKGROUND OF THE INVENTION

When a consumer purchases an item from a merchant, the consumer/purchaser is typically issued with a paper receipt which indicates the details of the purchase. The paper receipt typically identifies the name and location of the merchant, the name and number of each purchased item(s), the time and date of the purchase, scan/code number associated with the item, the price of the item (including any discount applied, sales tax), the total purchase price and the type of payment used (credit card/debit card, cash, check). The receipt can be retained as a proof of purchase, and can be used at a later stage when returning faulty goods, when claiming purchases as tax deductions, provisioning warranties, and for other reasons. That is, the consumer must have the paper receipt stored.

The management of paper/printed receipts becomes quite complex, particularly as the number of receipts to be managed increases. Over a period of time people often get inundated with a plethora of receipts which are difficult to maintain in any sort of order. Invariably, receipts are lost or fade through handling so as to become illegible, thereby resulting in the consumer/purchaser undesirably having no proof of purchase.

Consumers today prefer to minimize the amount of paper they receive when conducting a transaction. The need has arisen for receipts to be conveniently generated and then made accessible to a consumer and a merchant, without generating a paper receipt at the time of the transaction.

Attempts have been made to automate the invoicing process through the use of third-party service providers. However, existing electronic invoice presentment and payment systems have not typically utilized any system and method that can integrate specific information of the purchaser and the transactions from the different sources involved in a typical point-of sale transactions for generation, storage and retrieval of electronic receipts in a secured and efficient way.

Thus, there exists a need for an improved electronic invoicing presentment system that is cost-effective, simple to integrate into existing processes and systems, and allows efficient and secured generation, storage and distribution of electronic receipts against point-of-sale and/or other electronic transactions.

### OBJECTS OF THE INVENTION

An object of the present invention is to provide an electronic receipt system for replacement of paper receipts with electronic receipts for point-of-sale transactions.

Another object of the present invention is to provide an electronic receipt system wherein bank account of the consumer/purchaser is used as a unique identifier.

A further object of the present invention is to provide an electronic receipt system wherein data are securely stored and retrieved.

A still further object of the present invention is to provide an electronic receipt system wherein electronic receipts contain all the details of the purchase.

Another object of the present invention is to provide an electronic receipt system for which no infrastructure addition is required at the point of sale terminals.

Yet another object of the present invention is to provide an electronic receipt system wherein electronic receipt/digital receipt can be accessed remotely on a client device through a network.

A further object of the present invention is to provide an electronic receipt system which allows a consumer to select and reproduce a particular electronic receipt from the stored electronic receipts.

Details of the foregoing objects and of the invention, as well as additional objects, features and advantages of the invention will become apparent to those skilled in the art upon consideration of the following detailed description of the preferred embodiments exemplifying the best mode of carrying out the invention as presently perceived.

### SUMMARY OF THE INVENTION

The following presents a simplified summary in order to provide a basic understanding of some aspects of the disclosed invention. This summary is not an extensive overview, and it is not intended to identify key/critical elements or to delineate the scope thereof. Its sole purpose is to present some concepts in a simplified form as a prelude to the more detailed description that is presented later.

The present invention is directed to a system and method for electronic receipt generation, storage and distribution. In accordance with an embodiment, a person can use the user interface provided by the electronic receipt system and furnish the relevant details to become a registered user of the electronic receipt system (hereinafter referred to as e-receipt system). A registered user, having a user identity, referred to hereinafter as User ID, is allowed to provide details of one or more electronic payment tools owned by the registered user. In the context of the present invention, the term “electronic payment tools” refers to electronic payment solutions, electronic/digital payment means and electronic payment options and typically includes payment cards (e.g. credit/debit/gift/loyalty cards etc.), mobile payment solutions (e.g. Google Wallet, Apple Pay etc.) and online/internet banking options. Based on the details of the electronic payment tool the electronic receipt company computer system generates a bank identity, hereinafter referred to as Bank ID, against the electronic payment tool. The electronic receipt company computer system sends this Bank ID to the financial institution that maintains the bank account against the electronic payment tool. In this context, examples of financial institutions can include, but are not limited to, banks, building societies, credit unions, stock brokerages, asset management firms, savings and loans, money lending companies, insurance brokerages, insurance underwriters, dealers in securities, and similar businesses. Retail, wholesale, and service business, as well as manufacturers, may also process financial transactions disclosed herein. A bank system maintained by the financial institute associates the Bank ID with the appropriate bank account and stores this information in a database. Various stores or retailers and financial institutions can become member of the e-receipt system of the present invention. The point-of-sale (POS) system of the member stores, the financial institutions and the e-receipt company computer system can communicate with each other electronically over a network for sharing data related to financial transactions and purchase details of a registered user. For every financial transaction made at a POS of an e-receipt system member store by a registered user using registered payment card or mobile payment modes, the financial institution and the POS system send the Bank ID and transaction details to the e-receipt company computer system. The e-receipt company computer system associates these data to generate, store and distribute electronic receipts. For all of these data sharing the bank account of the user becomes the unique identifier.

### BRIEF DESCRIPTION OF THE DRAWINGS

In order to describe the manner in which features and other aspects of the present disclosure can be obtained, a more particular description of certain subject matter will be rendered by reference to specific embodiments that are illustrated in the appended drawings. Understanding that these drawings depict only typical embodiments and are not therefore to be considered to be limiting in scope, nor drawn to scale for all embodiments, various embodiments will be described and explained with additional specificity and detail through the use of the accompanying drawings in which:

FIG. 1 shows a general architecture of a system that operates in accordance with one embodiment of the present invention;

FIG. 2 illustrates a flowchart of the user and electronic payment tool registration process in accordance with one embodiment of the present invention; and

FIG. 3 illustrates a flowchart of the principal operations for generation, storage and distribution of electronic receipts in accordance with one embodiment of the present invention.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures and components have not been described in detail so as not to obscure the present invention.

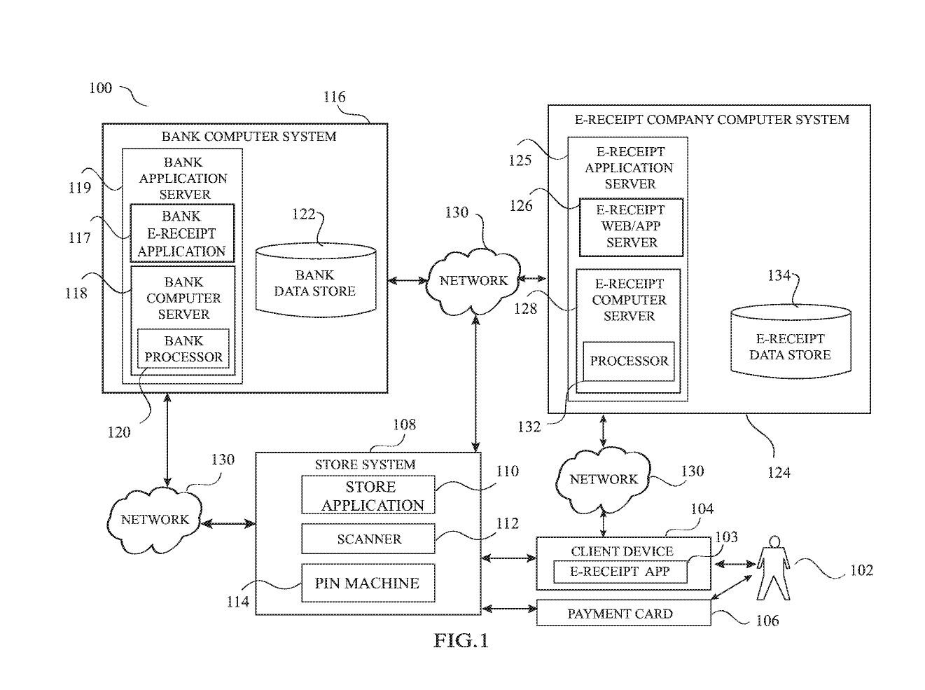

FIG. 1 illustrates the general architecture of an electronic receipt system 100 that operates in accordance with one embodiment of the present invention. Hereinafter, the term “electronic receipt system 100” is alternatively referred to as “e-receipt system 100”. The e-receipt system 100 comprises one or more client devices 104, one or more store systems 108, one or more bank computer systems 116 and one or more e-receipt company computer system 124, all communicatively connected with each other through one or more networks 130. The e-receipt system further comprises one or more payment cards 106.

The client device 104 may include various electronic components known in the art for this type of device. In this embodiment, the client device 104 may include a display, a processor, an input device (e.g., touch screen, keyboard, microphone, camera and/or other form of input device known in the art), a device transceiver for communication, a device memory, the e-receipt app 103 operably installed in the device memory, a local data store and a data bus interconnecting the aforementioned components. The term “transceiver” is defined to include any form of transmitter and/or receiver known in the art, for cellular, WIFI, radio, and/or other form of wireless or wired communication known in the art. Obviously, these elements may vary, or may include alternatives known in the art, and such alternative embodiments should be considered within the scope of the claimed invention. Examples of client device 104 may include, but not limited to mobile devices, tablets, hand-held or laptop devices, smart phones, personal digital assistants, desktop computers or any similar devices.

Reference to FIG. 1, the mobile application, or “app” 103 is a computer program that may be downloaded and installed in client device 104 using methods known in the art. Hereinafter, the mobile app 103 is referred to as e-receipt app 103. The e-receipt app 103 enables one or more persons to do various tasks related to the electronic receipt system of the present invention.

Reference to FIG. 1, example of payment card 106 may include, but not limited, credit card, debit card or any other card which uses a bank account for transactions. Further, examples of other electronic payment tools/means may include, but are not limited to, payment through emails connected to financial institutions, through phone number(s) connected to financial institutions, Bitcoins, through near field communication (NFC) enabled payment devices (payment cards, client devices), through scanning of fingerprints, iris, implemented chips etc.

Payment through any of the aforementioned electronic payment tools involve making a request for payment against a purchase at a checkout system or point-of-sale (POS) system of a retailer using an electronic payment tool and then processing of the request for payment to transfer of funds from a bank account held by the owner of the electronic payment tool. Payment through an electronic payment tool in the context of the present example may include online/internet based transactions also. In most of the cases, processing of the payment against a request made at a POS system through an electronic payment tool may involve one or more third parties between the merchant's or retailer's POS system and the bank or financial institution which issues the electronic payment tool to the user. For example, when a payment request is made at a POS system, the POS system sends the request to an acquirer which is usually a financial institution that signs up the retailer owning the POS system. The acquirer may then transmit the request to the issuer of the electronic payment tool through another third party (a card association in case of payment cards, for example). Finally, the issuer makes a decision on the transaction and transmits the decision back to the POS system of the retailer.

Reference to FIG. 1, the bank computer system 116 is the computer system or server of the financial institution which issues an electronic payment tool to the user. The term “Financial Institution” may refer to institutions that provide financial services to its clients or members by, for example, processing financial transactions for its clients or members. The bank computer system 116 generally comprises a bank application server 119, bank e-receipt application 117 operably installed on the memory of the bank computer system 116, a bank computer server 118 and one or more bank data store 122. The bank computer server 118 further comprises one or more bank processors 120. The bank processor 120 executes one or more instructions from the bank e-receipt application 117 to enable bank computer system 116 communicate with store system 108 and e-receipt company computer system 124 for tasks related to e-receipt system 100.

The Store System 108 comprises components required to carry out sales transactions. The term “store system” is referred herein to include all the typical components of a conventional checkout system or point-of-sale (POS) system of a retailer such as a store, a restaurant, a hotel, an airline, an electronic commerce website/store or any other entity that accepts payment through an electronic/digital payment tool. Store System 108 may comprise a processing unit, display device, bar code scanner, payment card (credit card, debit card, loyalty card, E-receipt card) authentication system (PIN machine), wireless communication means (e.g. Near Field Communication) for facilitating mobile payment services through client devices (e.g. Apple pay), local memory etc. A store application 110 is operatively installed on the local memory of the store system 108. By executing a set of instructions from the store application 110, the processing unit can make the store system 108 or the PIN machine 114 communicate with the e-receipt company computer system 124 over the network 130 for tasks related to the e-receipt system of the present invention.

The one or more e-receipt company computer systems 124 communicate with the client devices 104 over the network 130 to present a user interface for the e-receipt system of the present invention. The user interface of the e-receipt system of the present invention can be presented through a web browser or through the application e-receipt app 103 communicating with the one or more e-receipt company computer system 124 and is used for displaying, entering, and/or managing information related to an electronic receipt. As used herein, the term “network” generally refers to any collection of distinct networks working together to appear as a single network to a user. The term also refers to the so-called world wide “network of networks” or Internet which is connected to each other using the Internet protocol (IP) and other similar protocols. As described herein, the exemplary public network 130 of FIG. 1 is for descriptive purposes only and it may be wired or wireless. Although the description may refer to terms commonly used in describing particular public networks such as the Internet, the description and concepts equally apply to other public and private computer networks, including systems having architectures dissimilar to that shown in FIG. 1. The inventive idea of the present invention is applicable for all existing cellular network topologies or respective communication standards, in particular GSM, UMTS/HSPA, LTE and future standards.

With respect to the present description, the one or more e-receipt company computer system 124 may include any service that relies on a database system that is accessible over a network, in which various elements of hardware and software of the database system may be shared by one or more users of the system 100. The GUI or user interface provided by the one or more e-receipt company computer system 124 on the client devices 104 through a web browser or a mobile app may be utilized by the users for signing up, submitting data, receiving data etc.

The components appearing in the one or more e-receipt company computer system 124 refer to an exemplary combination of those components that would need to be assembled to create the infrastructure in order to provide the tools and services contemplated by the present invention. As will be apparent to one skilled in the relevant art(s), all of components “inside” of the one or more E-receipt company computer system 124 may be connected and may communicate via a wide or local area network (WAN or LAN).

The e-receipt company computer system 124 includes an e-receipt application server 125 and an e-receipt data store 134. The e-receipt application server 125 comprises an e-receipt web/app server 126 and an e-receipt computer server 128 that serves as the application layer of the present invention. It would be obvious to any person skilled in the art that, although described herein as the data being stored in a single database, different separate databases can also store the various data and files of multiple users.

The e-receipt web/app server 126 is a system that sends out web pages containing electronic data files in response to Hypertext Transfer Protocol (HTTP) or Hypertext Transfer Protocol Secure (HTTPS) requests from remote browsers (i.e. browsers installed in the client devices 104) or in response to similar requests made through the mobile app or mobile application 103 of the present invention installed on a client device 104. The e-receipt web/app server 126 can communicate with the E-receipt app 103 of the present invention and/or with a web browser installed on a client device 104 to provide the user interface required for the electronic receipt system.

The E-receipt company computer system 128 may include one or more processors 132, a random access memory (RAM) (not shown in figures) for temporary storage of information, and a read only memory (ROM) (not shown in figures) for permanent storage of information. E-receipt computer server 128 may be generally controlled and coordinated by an operating system software. The operating system controls allocation of system resources and performs tasks such as processing, scheduling, memory management, networking, and I/O services, among things. Thus, the operating system residing in system memory and executed by processor coordinates the operation of the other elements of the E-receipt company computer system 124.

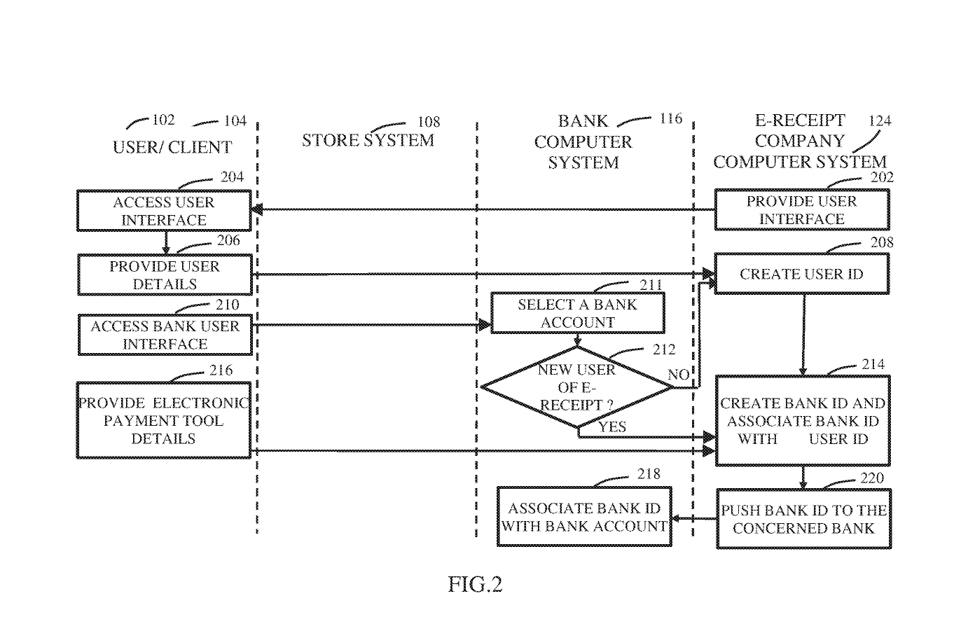

For availing the services of the e-receipt system 100, a person has to become its registered user. Reference to FIG. 1, a user 102 can download the e-receipt app 103 onto the client device 104 directly from the website provided by the e-receipt company computer system 124 or from a third party website (e.g. App Store) hosting the e-receipt app 103. By way of example, the client device 104 is a smart phone to which the e-receipt app 103 is downloaded and installed. The e-receipt company computer system 124 provides the user interface through the e-receipt app 103 or though a native web browser as in step 202 of FIG. 2. For registration of an electronic payment tool with the e-receipt company computer system 124, a user has to have an account with the e-receipt company computer system 124. A user can create a user identity with the e-receipt company computer system 124 by providing relevant personal information. A user can access the user interface on a client device 104 as in step 204 to provide the necessary user details as in step 206 of FIG. 2. For every registered user, a unique User ID is created by the e-receipt company computer system 124 as in step 208. To register an electronic payment tool owned by the registered user with the e-receipt company computer system 124 it is required that the relevant information of the electronic payment tool is provided to the e-receipt company computer system 124 as in step 216 of FIG. 2. The e-receipt system provides several options for submitting relevant information of the electronic payment tool. For example, one option of providing electronic payment tool details is by sending an image of the electronic payment tool to the e-receipt company computer system 124. Under this option the user 102 can open the e-receipt app 103 on the client device 104 and activate the camera of the of the client device 104 through the user interface provided by the e-receipt app 103 to take a picture of a credit card or debit card i.e. of electronic payment tool to capture the information provided on the face of the card. The e-receipt app 103 would then facilitate sending of the image of the credit/debit card to the e-receipt company computer system 124 over the network 130. The e-receipt company computer system 124 processes the picture or image so received to read the card information. The card information or the details of the electronic payment tool read by the e-receipt company computer system 124 from a card image includes the single-digit major industry identifier (MII), the six-digit issuer identifier number (IIN), the account number and the name of the card holder as it appears on the card. When the e-receipt company computer system 124 succeeds to read the card information from the received picture/image, it creates a Bank ID based on the submitted electronic payment tool details. The Bank ID is then associated with the User ID of the registered user, as in step 214, and this data is stored in the e-receipt data store 134. In some embodiments of the present invention, the e-receipt company computer system 124 will allow creation of multiple Bank IDs under a single User ID for multiple electronic payment tools belonging to a single user. If the e-receipt company computer system 124 fails to read the card information from the received image due to poor picture quality, a message is sent to the client device with a request to retake the picture. Again, if the card details retrieved from the card image indicate that the particular card/bank account is already registered with another User ID, a message is sent to the client device to inform about it. For those card images from which information were successfully retrieved, the e-receipt company computer system 124 then proceeds, as in step 220 of FIG. 2, to send the Bank ID to the concerned bank or financial institution that issued the electronic payment tool. To this end, it is required that the e-receipt company already has an agreement with the electronic payment tool issuing bank or financial institution and the bank or financial institution allows its computer system to interact with the e-receipt company computer system 124 and with the store system 108 for exchange of data related to the e-receipt system. The bank e-receipt application 117 enables the bank computer system 116 to associate the Bank ID with the corresponding bank account for the electronic payment tool maintained by the financial institution as in step 218 of FIG. 2 and this information is stored in the bank computer system.

Although, only one method of registration with the e-receipt system 100 i.e. registration with the help of the e-receipt app 103, has been described here, many other methods can be adopted in different embodiments of the present invention to get the registration done. For example, in some embodiments, for registration, instead of the e-receipt app 103, the website provided by the e-receipt company computer system 124 can be used. In this case, a picture of the credit/debit card can be taken with any camera and be uploaded to the e-receipt company computer system 124 through the website. While in some other embodiments, the bank computer system 116 facilitates creation of an account in the e-receipt system 100 using the bank account of a user as the unique identifier. In this instance, a user can access the bank computer system user interface, as in step 210, and select a bank account (if the user has more than one bank account in the same financial institution) as in step 211. The bank computer system then redirects the user to the e-receipt company computer system if it is found in step 212 that the user is not a registered user of the e-receipt company computer system. The e-receipt company computer system then allows the user to create a User ID as in step 208. The bank computer system 116 would communicate to the e-receipt company computer system 124 the electronic payment tool details to the e-receipt company computer system for creation of a User ID in the e-receipt system 100.

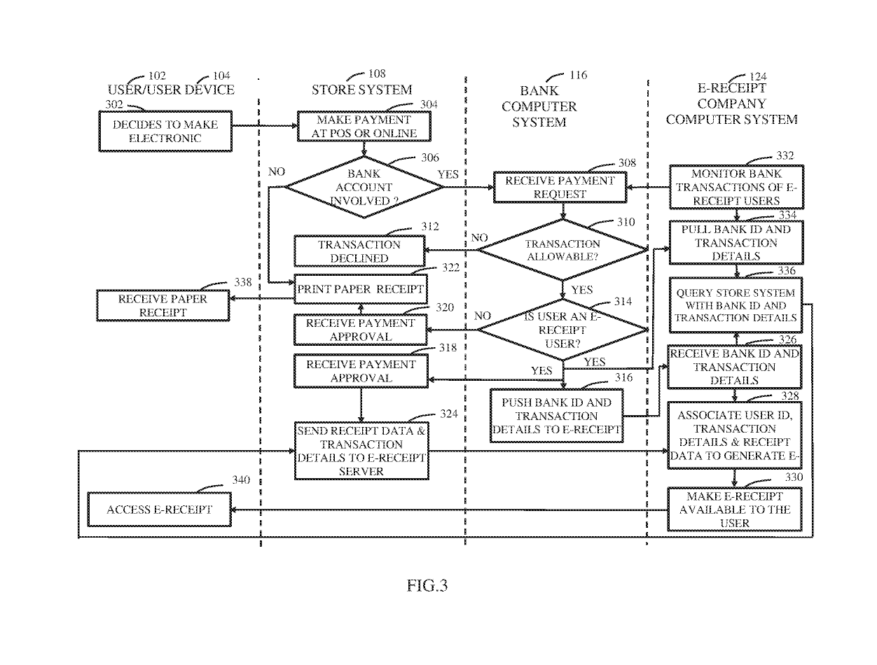

FIG. 3 illustrates the steps followed by the e-receipt system 100 for generation, storage and distribution of e-receipts in accordance with an embodiment of the present invention. Reference to FIG. 1, FIG. 2 and FIG. 3, by way of example, let us assume that the registered e-receipt user 102 is shopping at a store which is a part of the e-receipt system 100 i.e. the store has installed the store application 110 at its checkout or point-of-sale (POS) and the store system 108 can communicate with the bank computer system 116 and with the e-receipt company computer system 124. With the products to be bought user 102 goes to the POS and decides to make a payment, as in step 302, for the products after getting those scanned. The user 102 has to now make a payment against the purchase as in step 304 at the POS. If the user pays in cash or through any other mode which does not need a bank account the user can get a printed paper receipt at the POS against the transaction as in step 322. However, as determined in step 306, if the selected mode of payment uses a bank account of the customer (e.g. if the user 102 uses an electronic payment tool such as a payment card 106 or an NFC enables client device 104), the store system 108 sends the data related to the payment mode (credit card/debit card/NFC enabled phone etc.) to the concerned bank computer system 116. The communication between a store system 108 and a bank computer system 116 may involve sending the data through one or more intermediate third parties such as an acquire (not shown in the figures) and/or a card network (not shown in the figures) and, hereinafter, reference to communications between the store system 108 and the bank computer system 116 include all such communications involving the third parties. On receiving the payment request as in step 308, the bank computer system 116 proceeds to check whether the payment request can be allowed as in step 310. For reasons like lack of sufficient fund in the account or on exceeding permissible credit limit the transaction may get declined as in step 312. In case of an allowable transaction, the bank computer system 116 then checks its data store 122 as in step 314 to determine if it has any data to identify user 102 as a registered user of the e-receipt system 100. For this, the bank computer system 116 checks if any Bank ID is associated with the bank account corresponding to the electronic payment tool details received from the store system 108. If no association with a Bank ID is found then it is concluded that the user is not a registered user of the e-receipt system 100 and the bank computer system 116 simply approves the payment request and the store system 108 receives the payment approval confirmation as in step 320. The user can get a printed paper receipt against the transaction in the conventional way as in step 338.

If, upon analysis of the data, as in step 314, the bank computer system 116 finds out that the a Bank ID is associated with the bank account of the user 102 then it is concluded that the user 102 is registered with the e-receipt system 100. The bank computer system 116, as in step 316, pushes the Bank ID and the transaction details data to the e-receipt company computer system 124. In the context of the present invention, a transaction details data comprises a unique transaction identity (hereinafter referred to as Transaction ID) assigned against each transaction made through an electronic payment tool, a terminal identity (hereinafter referred to as Terminal ID) that defines the identity of the POS terminal (i.e. store system 108) and a date and time of transaction. At the same time, the store system 108 also receives the payment confirmation and the Bank ID from the bank computer system 116 as in step 318. If the store system 108 is already aware of the fact that the electronic payment tool used by the user 102 is registered with the e-receipt company computer system 124 then it proactively sends the receipt data and transaction details data to the e-receipt company computer system 124 as in step 324 of FIG. 3. Example of receipt data sent to the e-receipt company computer system 124 may include, but not limited to, name of each purchased item, the time and date of the purchase, scan/code number associated with the item, the price of the item (including any discount applied, sales tax), the total purchase price and the type of payment used (credit/debit card, mobile payment) etc.

On its part, the e-receipt company computer system 124, after receiving the Bank ID and the transaction details as in step 326, based on the transaction ID included in the transaction details data, associates the transaction details and the receipt data with the Bank ID and, then, based on the Bank ID, associates the data with the User ID as in step 328 to generate the e-receipt (electronic receipt) against the purchase made at the POS by the user 102. The data, so associated, is stored in the e-receipt data store 134. The user 102 can use the e-receipt app 103 or the website provided by the e-receipt company computer system 124 to access the e-receipts over a network on a client device 104 as in step 340.

In a preferred embodiment, e-receipt company computer system 124, as in step 332 of FIG. 3, monitors the transaction activities occurring through a bank account maintained at a financial institute for a registered user. If the e-receipt company computer system 124 detects any transaction activity happening in the bank account being monitored, then it pulls the Bank ID and the transaction details from the bank computer system 116 as in step 334. The e-receipt company computer system 124 then sends a request, as in step 336, to the store system 108 with the Bank ID and transaction details for getting the receipt data from the store system 108. In this case, the terminal ID is used to identify the POS or store system to which the request is to be sent from the e-receipt company computer system 124.

Against this query, on the basis of the transaction ID and date of transaction, the store system 108 sends the receipt data and the transaction details to the e-receipt company computer system 124 as in step 324. The e-receipt company computer system 124 can then generate an e-receipt as in step 328.

In a preferred embodiment, the exchange of data among the various components of the e-receipt system 100 occurs through secured encrypted form.

In some other embodiments, the store system 108 also analyses the information received from bank computer system 116 to check if the payee at the POS is a registered user of the e-receipt system 100.

In some embodiments, access to the e-receipts stored in the e-receipt company computer system 124 can also be provided to the merchants with request and approval of a registered user. This may help in settling return or refund or warranty related issues.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance It is also to be understood that additional or alternative steps may be employed.

References to “a processor” or “the processor,” can be understood to include one or more microprocessors that can communicate in a stand-alone and/or a distributed environment(s), and can thus be configured to communicate via wired or wireless communications with other processors, where such one or more processor can be configured to operate on one or more processor-controlled devices that can be similar or different devices. Furthermore, references to data store, unless otherwise specified, can include one or more processor-readable and accessible memory elements and/or components that can be internal to the processor-controlled device, external to the processor-controlled device, and can be accessed via a wired or wireless network.

Flowcharts are used to describe the steps of the present invention. While the various steps in the flowcharts are presented and described sequentially, some or all of the steps may be executed in different orders, may be combined or omitted, and some or all of the steps may be executed in parallel. Further, in one or more of the embodiments of the invention, one or more of the steps described above may be omitted, repeated, and/or performed in a different order. In addition, additional steps, omitted in the flowcharts may be included in performing this method. Accordingly, the specific arrangement of steps shown in FIG. 2 and FIG. 3 should not be construed as limiting the scope of the invention.

Preferred embodiments of this invention are described herein. Variations of those preferred embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. An electronic receipt system, said system comprising;
an electronic receipt company computer system, said electronic receipt company computer system configured to create a bank identity based on details of an electronic payment tool of a user and associate said bank identity with a user identity of said user maintained at said electronic receipt company computer system;
a bank computer system configured to associate said bank identity with a bank account maintained at a financial institution for said electronic payment tool, give a confirmation on said association of said bank account with said bank identity upon receiving a request for payment on use of said electronic payment tool for a transaction and to forward to said electronic payment company computer system said bank identity and a transaction details data; and
a store system configured to forward said request for payment to said bank computer system and, on receiving said confirmation on said association from said bank computer system, forward a receipt data and said transaction details data to said electronic receipt company computer system;
wherein said electronic receipt company computer system associates said user identity, said receipt data and said transaction details data based on a transaction identity included in said transaction details data to generate an electronic receipt against said transaction.

2. The system as in claim 1, wherein a user interface provided on a client device by said electronic receipt company computer system makes said electronic receipt accessible through said client device.

3. The system as in claim 2, wherein said user interface is provided through an e-receipt app operably installed on a device memory of said client device.

4. The system as in claim 2, wherein said user interface is provided through a web browser on said client device.

5. The system as in claim 1, wherein said store system is a conventional point-of-sale (POS) system with an additional store application installed.

6. The system as in claim 1, wherein said bank computer system is a computer system of a financial institution which manages said bank account for said electronic payment tool with an additional e-receipt application installed.

7. A method for electronic receipt management, said method comprising:
creating a bank identity for an electronic payment tool owned by a user based on details of said electronic payment tool by an electronic receipt company computer system;
associating said bank identity with a user identity of said user by said electronic receipt company computer system;
sending said bank identity to a bank computer system by said electronic receipt company computer system;
associating by a bank computer system a bank account maintained at a financial institution for said electronic payment tool with said bank identity;
pushing by said bank computer system to a store system said bank identity and a transaction details data upon receiving a request for payment from said bank account on use of said electronic payment tool for a transaction;
sending by said bank computer system to said electronic receipt company computer system said bank identity and said transaction details data;
sending by said store system to said electronic payment company computer system a receipt data and said transaction details data;
associating said user identity, said receipt data and said transaction details data based on a transaction identity included in said transaction details data to generate an electronic receipt; and
making said electronic receipt accessible through a client device communicably connected to said electronic receipt company computer system over a network.

8. The method as in claim 7, wherein said store system is a conventional point-of-sale (POS) system with an additional store application installed.

9. The method as in claim 7, wherein said bank computer system is a computer system of a financial institution which manages said bank account for said electronic payment tool with an additional e-receipt application installed.

10. The method as in claim 7, wherein said transaction details data is generated by said bank computer system.

11. The method as in claim 7, wherein said user identity is created by said electronic receipt company computer system based on a user details data provided by said user.

12. The method as in claim 7, wherein association of said bank identity for each of said electronic payment tool owned by said user with said user identity is permissible.

13. The method as in claim 7, wherein said electronic receipt is stored in a data store and is retrievable as per requirement.

14. A method for electronic receipt management, said method comprising:
creating a bank identity for an electronic payment tool of a user based on details of said electronic payment tool by an electronic receipt company computer system;
associating said bank identity with a user identity of said user by said electronic receipt company computer system;
sending said bank identity to a bank computer system by said electronic receipt company computer system;
associating, by a bank computer system a bank account maintained at a financial institution for said electronic payment tool with said bank identity;
monitoring of said bank account by said electronic receipt company computer system for a transaction activity against a payment request originating at a store system;
pulling of said bank identity and a transaction details data by said electronic receipt company computer system on detecting said transaction activity;
detecting said store system based on a terminal identity of said store system included in said transaction details data;
sending to said store system a request with said bank identity and said transaction details data;
retrieving a receipt data from said store system on the basis of a transaction identity included in said transaction details data;
associating said user identity, said receipt data and said transaction details data based on said transaction identity included in said transaction details data to generate an electronic receipt; and
making said electronic receipt accessible through a client device communicably connected to said electronic receipt company computer system over a network.

15. The method as in claim 14, wherein said electronic receipt company computer system, said bank computer system and said store system are communicably connected with each other over said network.

16. The method as in claim 14, wherein said store system is a conventional point-of-sale (POS) system with a store application provided by said electronic receipt company computer system installed on said store system.

17. The method as in claim 14, wherein said bank computer system is a computer system of a financial institution which manages said bank account for said electronic payment tool with an additional e-receipt application installed.

18. The method as in claim 14, wherein said user identity is created by said electronic receipt company computer system based on a user details data provided by said user.

19. The method as in claim 14, wherein association of said bank identity for each of said electronic payment tool owned by said user with said user identity is permissible.

20. The method as in claim 14, wherein said electronic receipt is stored in a data store and is retrievable as per requirement.
